(19) United States
(12) Patent Application Publication
(10) Pub. No.: US 2026/0355788 A1
(43) Pub. Date: Nov. 12, 2026

(54) SORTING OR GRADING SYSTEMS AND METHODS FOR CANNABIS FLOWERS

(71) Applicant: KEIRTON INC., Surrey (CA)

(72) Inventors: Behnam RAHIMI, Surrey (CA); Jay EVANS, Surrey (CA); Darrell MANN, Devon (GB)

(21) Appl. No.: 19/486,989

(22) PCT Filed: Jun. 2, 2023
(86) PCT No.: PCT/CA2023/050759

§ 371 Date: Nov. 24, 2025

(51) Int. Cl. B07C 5/342; B65G 47/46; G06T 7/00; G06V 10/774

(52) U.S. Cl. CPC B07C 5/3422; B65G 47/46; G06T 7/0012; G06V 10/774; B65G 2201/0202; G06T 2207/20081; G06T 2207/30188

(57) ABSTRACT

A system for sorting or grading cannabis flowers comprises a characterization unit having at least one camera, a feed unit configured to receive a cannabis flower and transport the cannabis flower to the characterization unit, a sorting unit configured to separate the cannabis flower based on a characterized category of the cannabis flower and a processor configured to perform: a cannabis flower characterization process to autonomously characterize the cannabis flower into one of a plurality of categories based on at least one image of the cannabis flower captured with the at least one camera and a meta-level process to control one or more parameters of the cannabis flower characterization process.

### TECHNICAL FIELD

The present invention pertains to sorting or grading systems and methods for cannabis flowers, and in particular, to systems and methods which can autonomously sort or grade cannabis flowers.

### BACKGROUND

It is known in the agricultural art to employ systems and methods to sort or grade harvested crops. For example, systems may sort or grade harvested crops such as blueberries. However, unlike blueberries which inherently have very small amounts of variation within a harvest (i.e. all harvested blueberries have a similar general appearance), cannabis flowers have a high degree of potential variability. The potential variability markedly increases the complexity of being able to autonomously sort or grade harvested cannabis flowers.

There is thus a need for systems and methods for autonomously sorting or grading cannabis flowers.

### SUMMARY OF THE INVENTION

One aspect of the invention provides a system for sorting or grading cannabis flowers comprising: a characterization unit comprising at least one camera; a feed unit configured to receive a cannabis flower and transport the cannabis flower to the characterization unit; a sorting unit configured to separate the cannabis flower based on a characterized category of the cannabis flower; and a processor configured to perform a cannabis flower characterization process to autonomously characterize the cannabis flower into one of a plurality of categories based on at least one image of the cannabis flower captured with the at least one camera and a meta-level process to control one or more parameters of the cannabis flower characterization process.

Another aspect of the invention provides a system for sorting or grading cannabis flowers comprising: a characterization unit comprising at least one camera; a feed unit configured to receive a cannabis flower and transport the cannabis flower to the characterization unit; a sorting unit configured to separate the cannabis flower based on a characterized category of the cannabis flower; and a processor configured to perform a cannabis flower characterization process to autonomously characterize the cannabis flower into one of a plurality of categories based on at least one image of the cannabis flower captured with the at least one camera, the cannabis flower characterization process characterizing the cannabis flower into one of the plurality of categories based at least partially on one or more of: presence of external fungi, presence of internal fungi, presence of mildew, flower and leaf colour variation, light burn, nutrition deficiency, nutrient burn, crows-feet, pistil colour, length or density, petioles length or density, different sizes or types of stem, different sizes or types of leaf, flower size, trichome size, colour, shape or density, different size or shape of Calix's (foxtails), presence of foreign material, flower structure, presence of insects and presence of insect damage.

Another aspect of the invention provides a method for characterizing a cannabis flower comprising the steps of acquiring at least one image of the cannabis flower and autonomously processing the at least one image of the cannabis flower with a machine learning model to characterize the cannabis flower into one of a plurality of categories based at least partially on one or more of: presence of external fungi; presence of internal fungi; presence of mildew; flower and leaf colour variation; light burn; nutrition deficiency; nutrient burn; crows-feet; pistil colour, length or density; petioles length or density; different sizes or types of stem; different sizes or types of leaf; flower size; trichome size, colour, shape or density; different size or shape of Calix's (foxtails); presence of foreign material; flower structure; presence of insects; and presence of insect damage.

Another aspect of the invention provides a method for modelling a cannabis plant morphology comprising the steps of training a machine learning model based on an initial fractal allometric phyllotactic patterning ontology; providing the machine learning model with additional training data comprising additional cannabis plant morphologies; varying one or more parameters of the machine learning model to improve accuracy of the machine learning model by further training the machine learning model based on the additional training data; and using the machine learning model to generate a model of the cannabis plant morphology.

Another aspect of the invention provides a system for sorting or grading cannabis flowers comprising: a characterization unit comprising at least one camera; a feed unit configured to receive a cannabis flower and transport the cannabis flower to the characterization unit; and a processor configured to perform a cannabis flower characterization process to autonomously characterize the cannabis flower into one of a plurality of categories based on at least one image of the cannabis flower captured with the at least one camera and a meta-level process to control one or more parameters of the cannabis flower characterization process.

Further aspects of the invention and features of specific embodiments of the invention are described below.

### BRIEF DESCRIPTION OF THE DRAWINGS

In drawings which illustrate non-limiting embodiments of the invention:

FIG. 1 is a schematic illustration of a cannabis flower sorting or grading system according to one embodiment of the invention.

FIG. 2 is a block diagram illustrating a cannabis characterization process according to one embodiment of the invention.

FIG. 3 is a block diagram illustrating a meta-level process according to one embodiment of the invention.

FIG. 4A is a partial front perspective view of a cannabis flower sorting or grading system according to one embodiment of the invention.

FIG. 4B is a front perspective view of the embodiment of FIG. 4A.

FIG. 4C is a front view of the embodiment of FIG. 4A.

FIG. 4D is a rear perspective view of the embodiment of FIG. 4A.

### DETAILED DESCRIPTION OF THE INVENTION

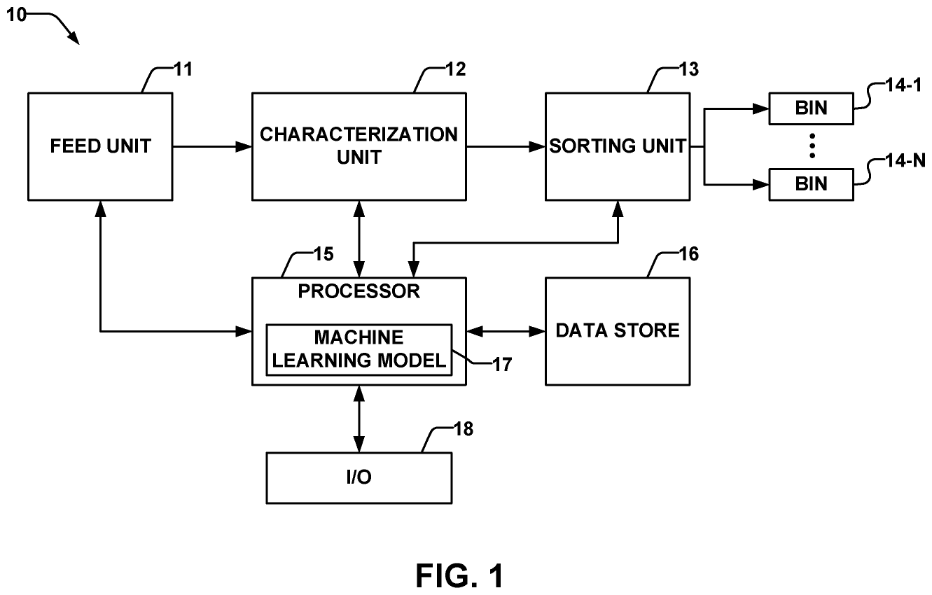

FIG. 1 schematically illustrates an example system 10 for sorting or grading cannabis flowers. System 10 comprises a feed unit 11, a characterization unit 12 and a sorting unit 13. System 10 may comprise a plurality of bins 14-1, . . . , 14-N (collectively bins 14) into which sorted or graded cannabis flowers are placed. Two or more of the aforementioned functional units may be combined into a single unit. In some embodiments, system 10 may not include sorting unit 13.

Feed unit 11 receives the cannabis flowers that are to be sorted and/or graded and feeds them into characterization unit 12. Feed unit 11 may, for example, comprise at least one conveyor which receives the cannabis flowers and physically moves the cannabis flowers to characterization unit 12. In some embodiments, feed unit 11 comprises one or more features such as one or more ribs, grooves, protrusions, etc. which are configured to spread out the cannabis flowers more evenly on the at least one conveyor.

Characterization unit 12 categorizes a received cannabis flower into one of a plurality of categories where each category corresponds to a particular type, grade, etc. of cannabis flowers. In some embodiments, at least one of the categories of the plurality of categories represents cannabis flowers which could not be categorized by characterization unit 12.

Characterization unit 12 comprises at least one camera. The at least one camera is operable to capture one or more images of a cannabis flower within an inspection zone of characterization unit 12. The inspection zone corresponds to a spatial portion of characterization unit 12. Image capture by the at least one camera may, for example, be triggered by entry of a cannabis flower into the inspection zone of characterization unit 12. Detection of a cannabis flower in the inspection zone by at least one sensor may, for example, trigger image capture. In some embodiments, cannabis flowers are in free fall within the inspection zone.

The at least one camera may, for example, have a resolution of at least 4 megapixels. In some embodiments, the at least one camera has a refresh rate of at least 10 frames per second. In some embodiments, the at least one camera is a high-speed camera having a refresh rate of at least 500 frames per second. In some embodiments, the at least one camera captures x-ray tomography, infrared and/or ultraviolet images.

In addition to the at least one camera, characterization unit 12 may comprise at least one mirror. The at least one mirror may be positioned to reflect a view of a cannabis flower that is complementary to the view of the cannabis flower that is in the field-of-view of the at least one camera. For example, if the at least one camera is positioned to capture images of a front side of the cannabis flower, the mirror may be positioned to reflect a rear view of the cannabis flower. The at least one camera may capture one or more images of the mirror.

In some embodiments, characterization unit 12 comprises a plurality of cameras. For example, characterization unit 12 may comprise a first camera configured to capture a first view of a cannabis flower (e.g. a front view of the cannabis flower) and a second camera configured to capture a second opposing view of the cannabis flower (e.g. a rear view of the cannabis flower). The plurality of cameras may be spaced circumferentially around the inspection zone. In some embodiments, the plurality of cameras are spaced circumferentially equidistant (i.e. equally) around the inspection zone. Each of the plurality of cameras may be like the at least one camera described herein.

Sorting unit 13 separates the cannabis flowers, for example, into bins 14 based on a determined category for each of the categorized cannabis flowers. Each bin 14 may correspond to a different category that can be assigned to a particular cannabis flower. At least one bin 14 may correspond to cannabis flowers which could not be categorized.

Sorting unit 13 may comprise a separation system which is operable to direct a particular cannabis flower into an appropriate bin 14.

For example, the separation system may comprise an air actuated system comprising at least one jet that is operable to direct a particular cannabis flower in a desired direction (e.g. into an appropriate bin 14). In some embodiments, a single air source provides the desired air-flow to the at least one jet. A plenum chamber and one or more valves may, for example, appropriately direct air to the at least one jet. The at least one jet may have a variable flow-rate. In some embodiments, the at least one jet is a high-pressure air jet. The air pressure of the at least one jet may depend on the density or a dryness level of the cannabis flowers. In some embodiments, the air pressure of the at least one jet is in a range from about 40 psi to about 120 psi. The at least one jet may comprise a nozzle having, for example, a circular, ovular or letterbox exit profile. The nozzle may have a first convergent section and a second divergent section downstream of the first section. At least a portion of the nozzle exit may have a castellated or fluted profile or a logarithmic spiral Coanda surface. In some embodiments, the nozzle has at least one variable geometry feature. In some embodiments, the nozzle is at least partially choked or chokable.

As another example, the separation system may comprise a mechanically actuated system. In some embodiments, the mechanically actuated system comprises one or more paddles which may be actuated to direct incident cannabis flowers in a desired direction (e.g. into the appropriate ones of bins 14).

As a further example, the separation system may comprise an electromagnetically actuated system. In some embodiments, the electromagnetically actuated system generates one or more electric fields which direct cannabis flowers in a desired direction (e.g. into the appropriate ones of bins 14) through application of one or more electrostatic forces on the cannabis flowers.

Prior to entering the appropriate ones of bins 14, the cannabis flowers may pass through a deceleration system of sorting unit 13 which is configured to decelerate the cannabis flowers to minimize damage to the cannabis flowers. The deceleration system may, for example, comprise a curved inlet geometry.

In some embodiments, sorting unit 13 comprises one or more chutes, guide channels, conveyors, etc. through which the cannabis flowers may pass. The cannabis flowers may, for example, pass through the one or more chutes, guide channels, conveyors, etc. prior to entering the appropriate ones of bins 14.

Bins 14 may receive and store the sorted or graded cannabis flowers. The sorted or graded cannabis flowers may also be transported within bins 14. A bin 14 may have at least one opening or aperture, a porous region and/or the like to facilitate release of air from the bin 14.

Processor 15 receives acquired images from characterization unit 12 and based on the received acquired images determines an appropriate category to be assigned to a particular cannabis flower. Processor 15 may control sorting unit 13 based on the determined category. Processor 15 may also control one or more parameters of feed unit 11 (e.g. an intake rate, movement of the conveyor, etc.).

Processing may be centralized or distributed. Where processing is distributed, information including software and/or data may be kept centrally or distributed. Such information may be exchanged between the different functional units of system 10 by way of a communications network, such as a Local Area Network (LAN), Wide Area Network (WAN), or the Internet, wired or wireless data links, electromagnetic signals or other data communication channel.

Acquired images, available categories to be assigned, assigned categories, etc. may be stored and/or retrieved from a data store 16.

System 10 may comprise a machine learning model 17 which may, for example, be run by processor 15. Machine learning model 17 may receive as input one or more images (e.g. raw acquired images or conditioned images as described elsewhere herein) of a cannabis flower and may output a category to be assigned to the cannabis flower. In some embodiments, machine learning model 17 receives as input one or more additional parameters (e.g. characteristics to be considered, a ranking or an importance value of the different characteristics to be considered, a desired resolution of the characterization (e.g. categorize into two categories, categorize into 6 categories, etc.), etc.) to be considered in determining the output category. Machine learning model 17 may adapt based on new input data and/or feedback from previous performed sorting or grading. In some embodiments, machine learning model 17 comprises a dynamically evolving machine learning model. The dynamically evolving machine learning model may be built on a fractal allometric phyllotactic ontology.

A machine learning model built on a fractal allometric phyllotactic ontology may be a model which is based on natural patterns or structures found in plants such as the principles of self-similarity, size relationship between different parts and the arrangement of parts. The machine learning model built on a fractal allometric phyllotactic ontology may learn to recognize patterns and/or structures in cannabis flowers based on these principles.

Non-limiting examples of possible fractal levels of a cannabis plant include one or more of:
a primary stem and branches that extend from the primary stem;
secondary branches that extend from the primary branches;
tertiary branches that extend from the secondary branches;
leaves that grow from each branch;
buds that grow from the stem and branches;
trichomes and pistils on the buds;
a branching pattern of the stem which can exhibit self-similarity across different scales;
an arrangement of leaves and buds on the stem which can exhibit self-similarity across different scales;
a shape and texture of individual leaves and buds which can have repeating patterns at different levels of magnification;
a distribution and density of trichomes on a surface of a plant which can vary across different regions and scales of observation;
an overall shape and structure of a plant as a whole which can exhibit fractal-like complexity in its branching and growth patterns;
etc.

In some embodiments, a machine learning model (e.g. a model in addition to machine learning model 17) is trained to model a cannabis plant morphology. The machine learning model may be trained to model an initial fractal allometric phyllotactic patterning ontology. The trained machine learning model may comprise an initial set of weighting parameters that correspond to the initial fractal allometric phyllotactic patterning ontology. For example, the initial set of weighting parameters may reflect an inherent structure of cannabis plant morphologies and its relationship to the ontology. The machine learning model may be provided additional training data comprising different cannabis plant morphologies. Using the additional training data, weighting parameters and/or an architecture (e.g. number of layers, etc.) of the machine learning model may be varied to better account for the different possible cannabis plant morphologies and improve accuracy of the machine learning model. Additionally, or alternatively, weighting parameters and/or the architecture of the machine learning model may be varied based on feedback from previously generated cannabis plant morphologies performed by the machine learning model. In some embodiments, the machine learning model trained to model a cannabis plant morphology is at least partially used by system 10 to characterize a cannabis flower.

A user or operator of system 10 may interact with system 10 via input/output (I/O) 18. I/O 18 may output for the user/operator of system 10 on, for example, a display one or more current system parameters (e.g. number of cannabis flowers which were sorted or graded, a sorting or grading rate, the categories into which the cannabis flowers are being sorted into, the current criteria for sorting or grading the cannabis flowers, etc.). A user may modify one or more of the system parameters through a keyboard, a touchscreen interface, one or more buttons and/or the like.

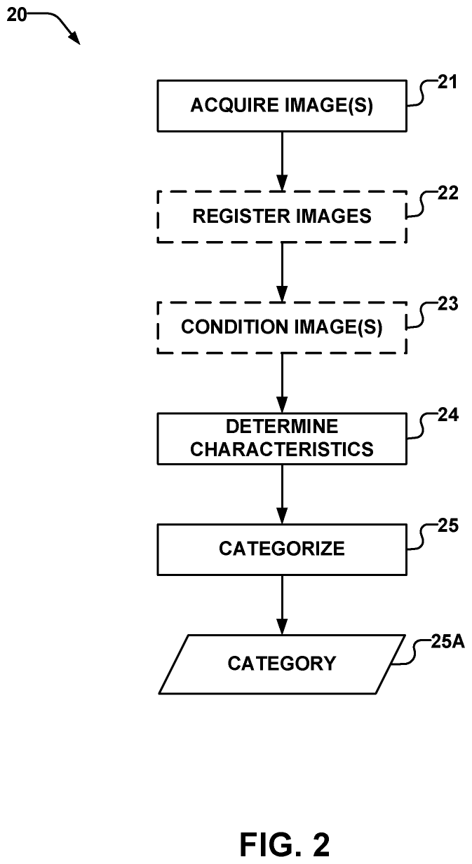

FIG. 2 is a block diagram illustrating an example method 20 for categorizing a cannabis flower. Method 20 may, for example, be performed by characterization unit 12 and processor 15.

In block 21, one or more images of the cannabis flower are acquired. The one or more images may be acquired simultaneously (e.g. using two cameras) or sequentially (e.g. capturing an image directly of the cannabis flower first followed by an image of a mirror reflecting a different view of the cannabis flower).

In block 22, acquired images of the cannabis flower are optionally registered together. For example, front and rear views of the cannabis flower may be registered together to form a single image of the cannabis flower. In some embodiments, a captured view of the cannabis flower is extracted from a reflecting surface of a mirror and registered with a directly captured (e.g. with a camera) view of the cannabis flower. In some such embodiments, the captured view of the cannabis flower extracted from the mirror is at least partially conditioned (e.g. re-sized, etc.) prior to being registered with the directly captured view of the cannabis flower.

In block 23, one or more images of the cannabis flower (either the acquired images or the registered image(s)) may optionally be conditioned. Conditioning the images may, for example, assist with extraction of features related to the cannabis flower. The conditioning may comprise filtering the images (e.g. to remove noise, artifacts, unwanted subject matter, etc.), re-sizing, rotating, making colour adjustments, adjusting brightness, adjusting contrast and/or the like. Block may at least partially be performed prior to block 22.

In block 24, one or more features or characteristics of the cannabis flower are autonomously determined. The one or more features or characteristics may include one or more of:
presence of external fungi such as mold;
presence of internal fungi such as mold (i.e. presence of fungi inside a cannabis flower);
presence of mildew;
flower and leaf colour variation (e.g. variations in white, brown, yellow, purple, green, red, orange colours);
light burn (e.g. determinable from white levels);
nutrition deficiency;
nutrient burn;
crows-feet (e.g. presence of wrinkles or crows-feet on a cannabis flower);
pistil colour, length and/or density;
petioles length and/or density;
different sizes and/or types of stem;
different sizes and/or types of leaf;
flower size;
trichome size, colour, shape and/or density;
different size and/or shape of Calix's (foxtails);
presence of foreign material;
flower structure (e.g. density of flower structure, shape, etc.);
presence of insects;
presence of insect damage (e.g. spots, holes, discolorations, feces, etc.);
etc.

The one or more features or characteristics of the cannabis flower may, for example, be autonomously determined using machine learning model 17. A plurality of the features or characteristics may be determined concurrently. A feature or characteristic may, for example, be determined by running a sub-process to determine the individual feature or characteristic. In some embodiments, block 24 comprises running a plurality of sub-processes to simultaneously determine a plurality of features or characteristics of the cannabis flower where each sub-process determines one feature or characteristic. In some embodiments, each sub-process comprises running a machine learning model.

In block 25, based on the determined features or characteristics of the cannabis flower a category 25A is assigned to the cannabis flower. As described elsewhere herein, if a specific category cannot be assigned to the cannabis flower, a category corresponding to unsuccessful attempts may be assigned to the cannabis flower or the cannabis flower may be directed to the appropriate bin 14 without assigning a category.

A meta-level process may monitor and dynamically control one or more parameters of the cannabis flower characterization process (e.g. method 20). The meta-level process may receive as input parameters (e.g. parameters 31A described elsewhere herein) such as an approximate size of the cannabis flowers, strain information, growing condition information, end-use case information (e.g. edibles, rolls, pre-rolls, smoking, etc.), results of the previously performed characterizations, etc. Different input parameters of the metal-level process may have different priorities or importance levels. Based at least partially on the received input parameters, the meta-level process may vary one or parameters of the cannabis flower characterization process (e.g. method 20).

The meta-level process may, for example, control input parameters to method 20 or machine learning model 17. For example, the meta-level process may set or vary how many acquired images of a cannabis flower are used to characterize the cannabis flower. As another example, the meta-level process may set or vary what views of a cannabis flower are used to characterize the cannabis flower.

Additionally, or alternatively, the meta-level process may set or vary what categories a cannabis flower may be categorized into. In some embodiments, the meta-level process may recognize that a new category may be created (e.g. if a threshold number of cannabis flowers whose characteristics don't match existing categories is reached). The new category may, for example, be added autonomously, or a user or operator may be notified and given the possibility to add the new category. In some embodiments, the meta-level process recognizes that one or more categories are not used or rarely used. The unused or rarely used categories may be deprioritized or removed autonomously or by a user or operator to, for example, improve computational efficiency.

Prior to generating a new category or modifying one or more parameters of the cannabis flower characterization process, the meta-level process may consider whether a new category should in fact be generated or whether the cannabis flower characterization process made a mistake. For example, the meta-level process may consider a degree of dissimilarity between a new variant of cannabis flower and existing variants as well as a frequency of occurrence of the new variant. If the new variant is significantly different from existing variants and occurs with a relatively high frequency, then the meta-level process may create a new category corresponding to the new variant. In contrast, if the new variant is only slightly different from an existing variant and occurs with a low frequency, then the meta-level process may determine that the inability to classify the purported new variant is a mistake and may reclassify the purported new variant as an existing variant.

Additionally, or alternatively, the meta-level process may vary sensitivity or characterizing parameters by, for example, varying threshold values for a cannabis flower to be categorized as belonging to a particular category, varying weights of one or more nodes in machine learning model 17, etc.

The meta-level process may vary or control the cannabis flower characterization process differently based on user input, pre-defined scenario specific criteria or the like. For example, if system 10 is being used for grading of cannabis flowers to be used for medical cannabis, the meta-level process may vary the cannabis flower characterization process to prioritize parameters related to the detection of mold or other contaminants which could pose a health risk to patients. As another example, if system 10 is being used for grading of cannabis flowers to be used for recreational purposes, then the meta-level process may vary the cannabis flower characterization process to prioritize parameters related to determining potency or visual appearance of the cannabis flowers which are important factors for recreational cannabis users.

In some embodiments, the meta-level process adjusts one or more parameters of the cannabis flower characterization process to improve (or maximize) accuracy and/or efficiency of system 10 for a particular category of cannabis flowers. For example, the meta-level process may adjust threshold values used to categorize flowers based on their colour, shape, size, etc. to improve the accuracy of system 10 for those characteristics. By the meta-level process optimizing the cannabis flower characterization process, system 10 may more accurately and efficiently sort the cannabis flowers into different categories thereby improving the overall quality of the sorting or grading performed by system 10.

As discussed above, the meta-level process may adjust one or more parameters of the cannabis flower characterization process to include a different set of categories of cannabis flower into which a particular cannabis flower may be characterized into. Since system 10 may be used to sort or grade many different types of cannabis flowers, system 10 may need to be configurable to accommodate different types of cannabis flowers with different characteristics (e.g. cannabis flowers with different levels of mold, discoloration, other defects, etc.). The meta-level process may adjust one or more parameters of the cannabis flower characterization process to dynamically accommodate different categories which may be needed thereby ensuring that system 10 can accurately and efficiently sort desired cannabis flowers into appropriate or desired categories.

The meta-level algorithm adjusting one or more parameters of the cannabis flower characterization process may facilitate system 10 to dynamically adapt to different types of cannabis flowers while maintaining high accuracy and efficiency across a wide range of input cannabis flowers.

In some embodiments, the meta-level process monitors the cannabis flower characterization process at set time intervals to, for example, improve computational efficiency, reduce power consumption, etc. The metal-level process may monitor the cannabis flower characterization process every second, every 10 seconds, every minute, every hour, every time a cannabis flower is characterized, every 10 times a cannabis flower is characterized, etc.

The meta-level process may, for example, be run on processor 15.

In some embodiments, the meta-level process varies or controls the cannabis flower characterization process in real time.

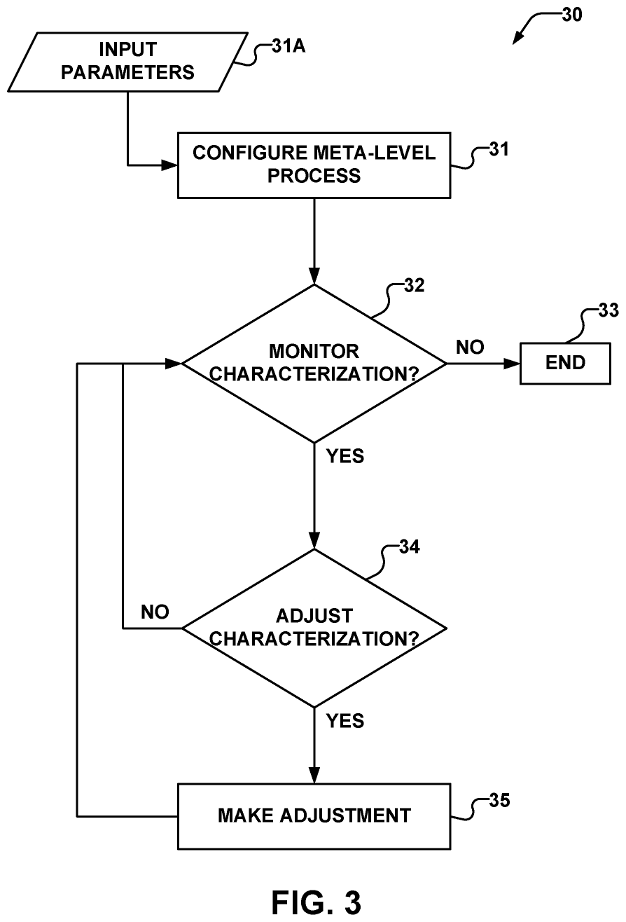

FIG. 3 is a block diagram illustrating an example meta-level process 30.

In block 31, meta-level process 30 is configured or initiated. For example, block 31 may include receiving one or more parameters 31A to be used to configure meta-level process 30.

In block 32, meta-level process 30 determines whether a cannabis flower characterization process is to be monitored. For example, block 32 may include determining whether a cannabis flower characterization process is currently being performed, when was the last time the cannabis flower characterization process was monitored, etc. If a cannabis flower characterization process is not to be monitored, then meta-level process 30 ends in block 33. Otherwise, meta-level process 30 proceeds to block 34.

In block 34, meta-level process 30 determines if one or more parameters of the cannabis flower characterization process being monitored need to be adjusted or varied. For example, block 34 may include determining how many cannabis flowers were not successfully classified into one of the currently available categories, user or operator input or feedback, etc. If no adjustments or variations are to be made, then meta-level process 30 may return to block 32. Otherwise, if an adjustment is to be made, meta-level process 30 proceeds to block 35.

In block 35, at least one parameter of the cannabis flower characterization process being monitored is adjusted. For example, as described elsewhere herein the adjustment may include addition or deletion of an available category for characterization, splitting a current category into a plurality of different categories, adjustment of threshold parameters used to perform the characterization, etc. In some embodiments, block 35 includes notifying a user or operator of system 10 of a proposed adjustment to the cannabis flower characterization process. In such cases, if the user or operator confirms the adjustment then block 35 may proceed to make the proposed adjustment.

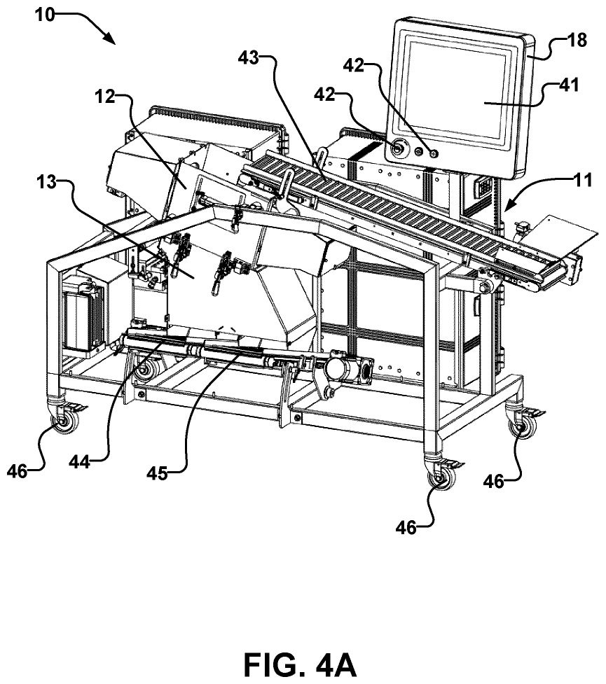

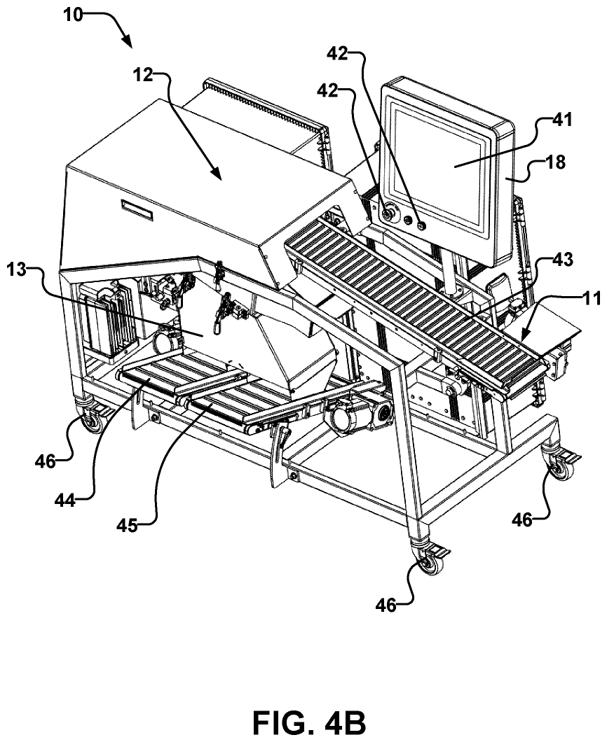

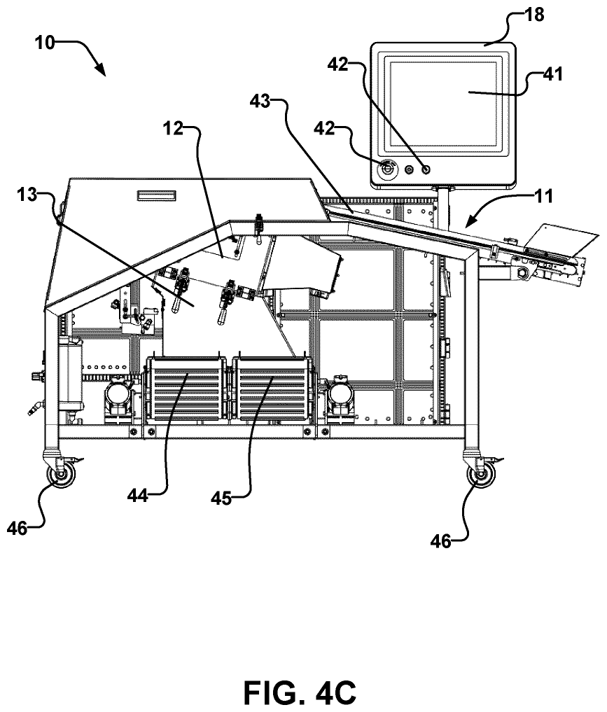

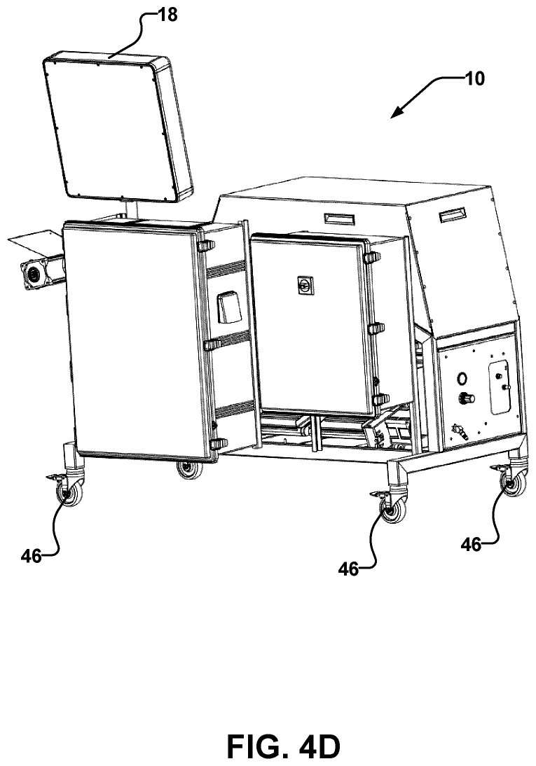

FIGS. 4A to 4D illustrate an example embodiment of system 10. The illustrated embodiment comprises a touchscreen display 41 and user interface buttons 42. Additionally, the illustrated embodiment comprises a first conveyor 43 as part of feed unit 11 as well as a second conveyor 44 and a third conveyor 45. Second conveyor 44 receives cannabis flowers characterized into a first category and transports them to, for example, an appropriate first storage bin (not shown). Third conveyor 45 receives cannabis flowers characterized into a second category and transports them to, for example, an appropriate second storage bin (not shown). As illustrated in FIGS. 4A to 4D, system 10 may be portable and may comprise a plurality of casters 46. System 10 may, for example, run on standard AC electrical power (e.g. 120 V and 60 Hz, 240 V and 50 Hz, etc.).

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”) and the like. Examples of configurable hardware are: one or more programmable logic devices such as programmable array logic (“PALs”), programmable logic arrays (“PLAs”) and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations and the like. For example, one or more data processors in a control circuit for a device may implement methods as described herein by executing software instructions in a program memory accessible to the processors.

The invention may also be at least partially provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including hard disk drives, optical data storage media including CD ROMs, DVDs, electronic data storage media including ROMs, flash RAM, EPROMs, hardwired or preprogrammed chips (e.g. EEPROM semiconductor chips), nanotechnology memory or the like. The computer-readable signals on the program product may optionally be compressed or encrypted.

In some embodiments, the invention may be implemented at least partially in software. The software may, for example, be run on commercially available graphical processor units (GPUs). For greater clarity, “software” includes any instructions executed on a processor and may include (but is not limited to) firmware, resident software, microcode, code for configuring a configurable logic circuit, applications, apps and the like. Both processing hardware and software may be centralized or distributed (or a combination thereof), in whole or in part, as known to those skilled in the art. For example, software and other modules may be accessible via local memory, via a network, via a browser or other application in a distributed computing context or via other means suitable for the purposes described above.

Software and other modules may reside on servers, workstations, personal computers, tablet computers, and other devices suitable for the purposes described herein.

Throughout the foregoing description and the drawings, in which corresponding and like parts are identified by the same reference characters, specific details have been set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

As will be apparent to those skilled in the art in the light of the forgoing disclosure, many alterations and modifications are possible in the practice of this invention without departing from the scope thereof. Accordingly, the scope of the invention is to be construed in accordance with the following claims.

1. A system for sorting or grading cannabis flowers, comprising:
(a) a characterization unit comprising at least one camera;
(b) a feed unit configured to receive a cannabis flower and transport the cannabis flower to the characterization unit;
(c) a sorting unit configured to separate the cannabis flower based on a characterized category of the cannabis flower; and
(d) a processor configured to perform:
a cannabis flower characterization process to autonomously characterize the cannabis flower into one of a plurality of categories based on at least one image of the cannabis flower captured with the at least one camera; and
a meta-level process to control one or more parameters of the cannabis flower characterization process, wherein the meta-level process controlling the one or more parameters comprises varying sensitivity of the characterization process.

2. : The system according to claim 1, wherein the cannabis flower characterization process characterizes the cannabis flower into one of the plurality of categories based at least partially on one or more of:
(a) presence of external fungi;
(b) presence of internal fungi;
(c) presence of mildew;
(d) flower and leaf colour variation;
(e) light burn;
(f) nutrition deficiency;
(g) nutrient burn;
(h) crows-feet;
(i) pistil colour, length or density;
(j) petioles length or density;
(k) different sizes or types of stem;
(l) different sizes or types of leaf;
(m) flower size;
(n) trichome size, colour, shape or density;
(o) different size or shape of Calix's (foxtails);
(p) presence of foreign material;
(q) flower structure;
(r) presence of insects; and
(s) presence of insect damage.

3. The system according to claim 1, wherein the meta-level process controlling the one or more parameters of the cannabis flower characterization process comprises the meta-level process controlling an organization of categories in the plurality of categories.

4. The system according to claim 3, wherein controlling the organization of categories in the plurality of categories comprises adding or removing a category from the plurality of categories.

5. The system according to claim 1, wherein the meta-level process varying sensitivity of the characterization process comprises varying weights of the one or more parameters or threshold values for characterizing cannabis flowers.

6. The system according to claim 1, wherein the processor is configured to concurrently perform the cannabis flower characterization process and the meta-level process.

7. The system according to claim 1, further comprising a machine learning model, the machine learning model configured to at least partially perform the cannabis flower characterization process.

8. The system according to claim 7, wherein the machine learning model comprises a dynamically evolving machine learning model.

9. The system according to claim 7, wherein the machine learning model is based on a fractal allometric phyllotactic ontology.

10. The system according to claim 7, wherein the processor is configured to at least partially run the machine learning model.

11. The system according to claim 1, wherein the characterization unit further comprises a mirror, the mirror positioned to reflect a view of the cannabis flower that is complimentary to a field-of-view of the at least one camera.

12. The system according to claim 11, wherein the at least one camera is operable to capture one or more images of the mirror.

13. The system according to claim 11, wherein the processor is configured to extract the view of the cannabis flower from the mirror and register the extracted view of the cannabis flower with an image of the cannabis flower captured directly with the at least one camera.

14. The system according to claim 1, wherein the characterization unit comprises a first camera and a second camera, the first and second cameras configured to capture different views of the cannabis flower.

15. The system according to claim 14, wherein the first and second cameras are positioned circumferentially equidistant.

16. The system according to claim 1, wherein the characterization unit is configured to place the cannabis flower into free fall within the characterization unit.

17. The system according to claim 1, wherein the sorting unit comprises a separation system operable to direct the cannabis flower in a specified direction, the separation system comprising an air actuated system, a mechanically actuated system or an electromagnetically actuated system.

18. The system according to claim 1, wherein the feed unit comprises at least one conveyor.

19. A system for sorting or grading cannabis flowers, comprising:
(a) a characterization unit comprising at least one camera;
(b) a feed unit configured to receive a cannabis flower and transport the cannabis flower to the characterization unit;
(c) a sorting unit configured to separate the cannabis flower based on a characterized category of the cannabis flower; and
(d) a processor configured to perform a cannabis flower characterization process to autonomously characterize the cannabis flower into one of a plurality of categories based on at least one image of the cannabis flower captured with the at least one camera; a meta-level process to control one or more parameters of the cannabis flower characterization process, the cannabis flower characterization process characterizing the cannabis flower into one of the plurality of categories based at least partially on one or more of:
presence of external fungi;
presence of internal fungi;
presence of mildew;
flower and leaf colour variation;
light burn;
nutrition deficiency;
nutrient burn;
crows-feet;
pistil colour, length or density;
petioles length or density;
different sizes or types of stem;
different sizes or types of leaf;
flower size;
trichome size, colour, shape or density;
different size or shape of Calix's (foxtails);
presence of foreign material;
flower structure;
presence of insects; and
presence of insect damage.

20. A method for characterizing a cannabis flower, comprising:
(a) acquiring at least one image of the cannabis flower; and
(b) autonomously processing the at least one image of the cannabis flower with a machine learning model to characterize the cannabis flower into one of a plurality of categories based at least partially on one or more of:
presence of external fungi;
presence of internal fungi;
presence of mildew;
flower and leaf colour variation;
light burn;
nutrition deficiency;
nutrient burn;
crows-feet;
pistil colour, length or density;
petioles length or density;
different sizes or types of stem;
different sizes or types of leaf;
flower size;
trichome size, colour, shape or density;
different size or shape of Calix's (foxtails);
presence of foreign material;
flower structure;
presence of insects; and
presence of insect damage; and
(c) performing a meta-level process that controls one or more parameters of the machine learning model to characterize the cannabis flower.

21. A method for modelling a cannabis plant morphology, comprising:
(a) training a machine learning model based on an initial fractal allometric phyllotactic patterning ontology;
(b) providing the machine learning model with additional training data comprising additional cannabis plant morphologies;
(c) varying one or more parameters of the machine learning model to improve accuracy of the machine learning model by further training the machine learning model based on the additional training data; and
(d) using the machine learning model to generate a model of the cannabis plant morphology.

22. A computer program product comprising a computer readable memory storing computer executable instructions thereon that when executed by a computer perform the method steps of claim 20 or 21.

23. A system for sorting or grading cannabis flowers, comprising:
(a) a characterization unit comprising at least one camera;
(b) a feed unit configured to receive a cannabis flower and transport the cannabis flower to the characterization unit; and
(c) a processor configured to perform:
a cannabis flower characterization process to autonomously characterize the cannabis flower into one of a plurality of categories based on at least one image of the cannabis flower captured with the at least one camera; and
a meta-level process to control one or more parameters of the cannabis flower characterization process, wherein the meta-level process controlling the one or more parameters comprises varying sensitivity of the characterization process.
